(19) United States
(12) Patent Application Publication
(10) Pub. No.: US 2024/0387963 A1
(43) Pub. Date: Nov. 21, 2024

(54) Battery Module Having Several Individual Battery Cells

(71) Applicant: Mercedes-Benz Group AG, Stuttgart (DE)

(72) Inventors: Marius Yves KUHN, Winterlingen (DE); Klaus HUBER, Esslingen am Neckar (DE)

(21) Appl. No.: 18/689,220

(22) PCT Filed: Feb. 2, 2023
(86) PCT No.: PCT/EP2023/052600

§ 371 Date: Mar. 5, 2024

(30) Foreign Application Priority Data
Feb. 10, 2022 (DE) 10 2022 000 513.1

(51) Int. Cl. H01M 50/578; H01M 10/613; H01M 10/656; H01M 50/213; H01M 50/342; H01M 50/51

(52) U.S. Cl. CPC H01M 50/578; H01M 10/613; H01M 10/656; H01M 50/213; H01M 50/3425; H01M 50/51; H01M 2200/20

(57) ABSTRACT

A battery module has several individual battery cells that are designed as round cells. The individual battery cells are arranged one behind the other in several strings and are electrically connected in series within the respective string. Each of the strings is arranged within a closed tubular volume where a device for severing the electrical contact of at least one string in the event of an unpermitted increase in pressure in at least one of the individual battery cells is provided within the tubular volume of the string.

### BACKGROUND AND SUMMARY OF THE INVENTION

The invention relates to a battery module having several individual battery cells of the kind defined herein.

Batteries constructed from battery modules having several individual battery cells are known to an extent from the prior art. A typical structure for the individual battery cells is the embodiment as a so-called round cell. This enables different arrangements. For example, DE 10 2009 000 673 A1 describes a battery module in which a plurality of round cells is respectively grouped around a clearance. This can preferably be implemented in a hexagonal arrangement, wherein the clearance can have a filling made of material that conducts heat effectively or can also be designed as a conduit for the through-flow of a cooling medium. A further structure, in which several of the individual battery cells in the form of round cells are arranged one behind the other, and are thus electrically connected to each other, is for example also known from DE 10 2016 103 667 A1.

If such battery modules are installed to provide electric drive power in a vehicle, the battery modules typically have a relatively high energy density. According to the current prior art, lithium-ion cells are frequently used for this. If a thermal problem arises within one of the cells, then an excessive pressure builds up, and a so-called thermal runaway, and thus a thermal runaway of the entire battery module can arise. To counteract a thermal runaway, the housings of the individual battery cells have rupture elements that open the housing in the event of an excessive pressure within the individual battery cell to thus reduce the excessive pressure and to remove the electrolyte from the individual battery cell. In the ideal scenario, a thermal runaway can thus be limited to one or just a few cells, which is a decisive advantage with regard to the safety of a battery constructed from such battery modules.

The hot gases that are discharged, which are also described as venting gases, can be combustible or even explosive. Ignition of the gases, for example via a short-circuit or arcing, should thus be prevented if possible.

EP 2 557 615 A1 describes a battery for a motor vehicle, the battery consisting of several individual modules. Individual battery cells are arranged within the modules. These individual battery cells respectively have a device for interrupting current (CID—Current Interruption Device) for interrupting a current flow from the respective individual battery cell in the event of an increase in pressure during a thermal runaway of the battery.

JP 2011-135657 A also describes something similar. The aforementioned document is also concerned in a further exemplary embodiment with interconnecting several individual cells and providing each of these series of connected individual cells with a shared CID.

JP 2019-145490 A describes a battery, in which several round individual battery cells are arranged in a shared closed tube.

Reference can further be made to US 2013/0280559 A1, DE 10 2017 212 223 A1 and to DE 10 2008 013 188 A1 as further prior art. These documents substantially show devices for reducing pressure in individual battery cells, which ensure, via rupture elements or the like that break in the event of an increase in pressure, that the excessive pressure escapes.

The object of the present invention is to disclose an improved battery module having several individual battery cells designed as round cells, which enables a safe operation of such a battery module.

The battery module according to the invention comprises several individual battery cells designed as round cells, the individual battery cells being arranged one behind the other in several strings. The round cells of each individual string are electrically connected to one another in series, which can for example be implemented by designing the cup-shaped housing of each of the individual battery cells as a negative pole and as a positive pole that protrudes forwards, such that the individual battery cells-much like batteries for use in small appliances-can be placed one behind the other, and thus connected in series. According to the invention, each of the strings is arranged in a closed tubular volume. A device for severing the electrical contact of at least one string in the event of an unpermitted increase in pressure in at least one of the individual battery cells is provided in the tubular volume of the string. Thus, if a thermal propagation or a thermal runaway arises in one of the individual battery cells, pressure typically increases in this cell. A rupture element in the cup of the cell will then burst open upon exceeding a critical limit pressure and the venting gases will flow out of the individual battery cell. These venting gases then reach the tubular volume of the string in question and lead to an increase in pressure there.

In the battery module according to the invention, via the device for severing the electrical contact of the string in the event of such an unpermitted increase in pressure, this string is severed electrically from the further strings of the battery module and in some instances from further battery modules that form the battery. The current path is thus interrupted at a relatively low voltage level that is defined only via the number of individual battery cells within the string. The ignition voltage that is potentially available to ignite the venting gases is significantly reduced, which represents a decisive safety advantage.

In the battery module according to the invention, at least one electrical contact plate is designed which is in electrical contact with at least two of the strings. The strings can thus be connected differently within the module depending on the number of strings. For example, they can thus all be connected in parallel or all in series, or they can be connected in groups in parallel or in series, with these groups then being connected in series or in parallel in turn. All this can be implemented via one or several electrical contact plates, which are preferably arranged on the end and on the beginning of the corresponding tubular volumes and the strings of the individual battery cells arranged therein.

According to the invention, this contact plate is designed as a rupture element. The electrical contact plate is connected to a housing of the battery module in such a way that the electrical contact plate is jettisoned in the event of an excessive pressure. Thus, on the one hand, it is made possible to relieve pressure within the tubular volume and, on the other hand, the electrical contact of all the strings in contact with the respective plate within the battery module is severed. As an alternative or in addition, an actuator can also be present to remove the contact plate, for example to jettison the contact plate via an explosive charge if an increase in pressure has been directly or indirectly recognized via a sensor.

In an advantageous embodiment of the invention, the device can have a detection apparatus for at least indirectly recording the increase in pressure and at least one actuator triggered thereby. The pressure can thus be directly or indirectly recorded, whereby an actuator can be triggered. This can be, for example, the triggering of a pyro fuse to separate the electrical contact or to jettison a contact element from the string of the individual battery cells.

In this variant having a direct or indirect pressure sensor, the further advantage arises that it becomes possible to open the current paths even before the pressure has risen to the point where venting gases are released, which venting gases can then ignite in some instances. The risk of an ignition of the venting gases is thus further reduced.

According to a further very favorable embodiment of the battery module according to the invention, it can further be provided that the device has a rupture element, wherein the latter forms the electrical contact or a conductor forming the electrical contact runs over the rupture element. This rupture element for the tubular volume of the string in question will thus break automatically at a critical excessive pressure, in order to thus release the excessive pressure into the environment, preferably along a pre-determined safe venting path. In this embodiment of the device, when the rupture element breaks, the electrical contact is destroyed at the same time, either because this contact is formed by the rupture element itself or because a conductor runs over the intended breaking point of the rupture element, which is destroyed when the rupture element is activated to interrupt the current path.

An exceptionally favorable development of the battery module according to the invention provides that at least one flow conduit is designed between the individual battery cells of the series and the wall of the tubular volume. Such a flow conduit ensures that gases exiting from one of the individual battery cells are safely and reliably guided within the tubular volume and for example arrive at the beginning or at the end of the tubular volume when a rupture element is arranged there without first deforming the tubular volume. Such conduits can for example be created by a ribbed surface of the wall of the tubular volume.

According to an exceptionally favorable development of the battery module according to the invention, it can also be provided that the flow conduit is implemented by spiral wrapping of the individual battery cells with a flexible material, e.g., a wire or stranded wire or an elastic round material or a band made of elastomer, plastic or the like. If these individual battery cells that have been wrapped are then introduced into the tubular volume, a spiral conduit forms. In the case of a sufficiently flexible material, e.g., a rubber braid with an oval or round cross-section, a secure fixing of the individual battery cells within the tubular volume can simultaneously be guaranteed without impeding their potential movement when charging and discharging, where the individual battery cells become slightly larger and slightly smaller with regard to their diameter.

According to an exceptionally favorable development of the battery module according to the invention, the at least one tubular volume can be arranged next to a conduit that is flowed through by a cooling medium. In particular, this can be a completely or partially hexagonal arrangement of several such tubular volumes around the cooling medium conduit.

The cooling medium conduit can be connected to the cooling conduit via a pressure protection device and/or fuse made of a material that breaks and/or melts in the event of a thermal runaway. Thus, venting gases are not (only) for example guided away for example into the housing around several such battery modules, but into the cooling medium conduit, such that the venting gases can be cooled in a targeted manner and can be removed with the cooling medium.

In addition to such a defined venting path via the cooling medium, by the targeted arrangement of the rupture point/intended breaking point respectively on one end of the tubular volume, a venting conduit can also be implemented out of the battery module into a battery housing, which, according to a very advantageous embodiment, surrounds the battery module, from which housing the gases can then be diverted in a manner known per se, typically via a further rupture element and a venting conduit, in a highly targeted manner into a non-critical region outside of the battery.

Further advantageous embodiments of the battery module according to the invention result from the further dependent sub-claims and become clear with reference to the exemplary embodiment, which is described in more detail in the following with reference to the figures.

### BRIEF DESCRIPTION OF THE DRAWINGS

FIG. 1 shows a schematic arrangement of a part of a battery module according to the invention in regular operation;

FIG. 2 shows, in a first exemplary embodiment, a depiction analogous to that of FIG. 1 in the event of a thermal event;

FIG. 3 shows, in a second exemplary embodiment, a depiction analogous to that of FIG. 1 in the event of a thermal event;

FIG. 4 shows a schematic depiction of a rupture element in the battery module according to the invention in regular operation;

FIG. 5 shows a depiction analogous to that of FIG. 4 in the event of a thermal event; and

FIG. 6 shows an aerial view of a battery having several battery modules according to the invention.

### DETAILED DESCRIPTION OF THE DRAWINGS

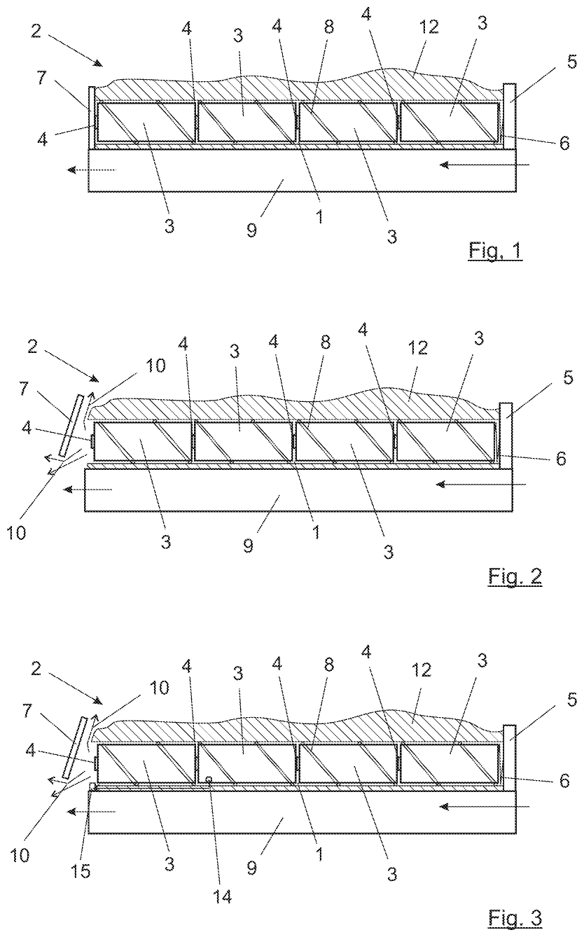

In the depiction of FIG. 1, a tubular volume 1 of a battery module 2 shown schematically can be seen. In the exemplary embodiment depicted here, four individual battery cells 3 are arranged one behind the other in series in this tubular volume 1. They are connected to each other electrically in series, for example because their cup-shaped housings form the negative battery pole and a positive battery pole 4 is designed, in the depiction of FIG. 1, on the left side of the individual battery cells 3. If the individual battery cells 3 are now installed one behind the other in the tubular volume 1 and pressed into each other, for example via a negative contact plate 5 and a spring 6 on the right side and a positive contact plate 7 on the left side, then the individual battery cells 3 are connected with one another in series and a voltage corresponding to their number is present between the two contact plates 5, 7.

In case one of the individual battery cells 3 of this string of individual battery cells 3 experiences thermal runaway and venting gases empty into the region of the tubular volume 1, in the exemplary embodiment depicted here, the individual battery cells 3 are spirally wrapped with a cord-like element 8 to thus create a spiral path for potential venting gases. The cord 8, which can for example be designed as a rubber cord, as a wire, as a stranded wire or the like, additionally holds the individual battery cells 3 securely in their position in the tubular volume 1, and simultaneously permits the individual battery cells 3 to breathe to a certain extent, thereby denoting the increase and decrease in volume during charging and discharging. In the depiction of FIG. 1, a cooling medium conduit 9 is additionally indicated next to the tubular volume 1, the cooling medium conduit being flowed through corresponding to the arrows by a liquid or, in some instances, also by a gaseous cooling medium to reliably remove waste heat that arises in the region of the individual battery cells 3.

Now, if the previously mentioned thermal event arises in one of the individual battery cells 3 within the tubular volume 1, the corresponding excessive pressure of the venting gases in the volume 1 will spread out. For example, the tubular volume 1 has intended breaking points or rupture elements in the region of its positive contact plate 7, the intended breaking points or rupture elements breaking in such a case and releasing a venting path for the gases. This is indicated in the depiction of FIG. 2 by the contact plate 7 connected to a housing 12 of the battery module 2 by means of an intended breaking point. This contact plate 7 can, for example, be adhesively bonded to the housing 12 such that it detaches in the event of a critical excessive pressure in the volume 1. The venting gases symbolized by the arrows 10 are then emitted into a battery housing (not depicted here), for example, and directed away from the latter in a targeted manner into a non-critical region.

When the positive contact plate 7 is jettisoned, the pressure is relieved. Simultaneously, however, the electrical contact of the string of the individual battery cells 3 in the tubular volume 1 is also interrupted. The voltage is interrupted at a relatively low level, as only the voltage of the individual battery cells 3 located within the volume 1 is present. The ignition voltage that is potentially available to ignite the venting gases is thus reduced, which increases safety.

In principle, it is sufficient to take the string of the individual battery cells 3 in question with the cell 3 in which thermal runaway is arising out of the current path. It is preferable, however, to separate all of the current paths within the battery module 2 if several strings of individual battery cells 3 are present. This can ideally be obtained by jettisoning the entire contact plate 7.

In FIG. 3, like the depiction in FIG. 2, an alternative embodiment is shown. Instead of jettisoning the contact plate 7, on the one hand to relieve pressure of the tubular volume 1 and on the other hand to separate the electrical contact of the individual battery cells 3 of the string, a pressure sensor 14 can here be seen, the pressure sensor being connected to an actuator 15, for example a pyro charge, in order, in the event of an increase in pressure, to jettison the contact plate 7 or to support its jettisoning via the forces of the increase in pressure.

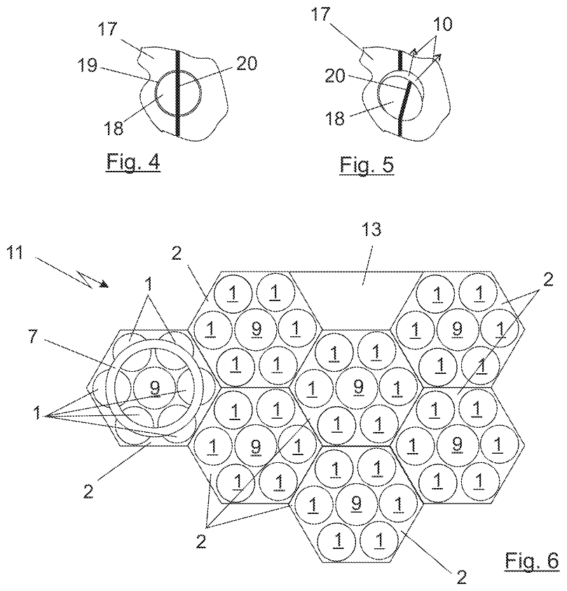

A further passive possibility, which is substantially the same as the variant described in FIG. 2, in which the contact plate 7 is entirely jettisoned, can be seen in the depictions of FIGS. 4 and 5. The undestroyed state can be seen in FIG. 4. Instead of the electrical contact plate 7 in the depiction of FIG. 2, there is here a sealing plate 17 that does not conduct electricity, which seals the tubular volume 1. This sealing plate 17 that does not conduct electricity has a rupture element labelled 18, which is here designed as a disc connected over an intended breaking point 19. An electrical conductor 20 runs over the rupture element 18, via which the correspondingly assigned string of the individual battery cells 3 is electrically contacted. The depiction of FIG. 5 shows the case in which the increase in pressure within the tubular volume 1 has already taken place. The disc of the rupture element 18 is broken along the intended breaking point 19. As is indicated by the arrows which are in turn labelled 10, venting gas flows out of the opening created by the rupture element 18 breaking. At the same time as the rupture element 18 breaks, the electrical conductor 20 is also destroyed, such that the electrical contact of the individual battery cells 3 of the string produced via the conductor is interrupted. Unlike when a sensor is used, this structure, similar to the structure described in FIG. 2, is purely passive.

In the depiction of FIG. 6, an entire battery 11 can be seen, which is constructed from several such battery modules 2. Each of the battery modules 2 comprises a cooling conduit 9, which is arranged centrally within a hexagonal arrangement of six of the tubular volumes 1, the volumes then being correspondingly equipped with the individual battery cells 3. As an alternative, seven volumes 1 having individual battery cells 3 would be conceivable if the cooling conduit is not required because the cooling is unnecessary, is arranged between the volumes 1 or, for example, is implemented via one of the head plates 5, 7. Each of the battery modules 2 can have a single positive contact plate 7 on one side and negative contact plate on the other side, which can be jettisoned in the event of a thermal propagation, and thus a thermal runaway of the individual battery cells 3 in one of the volumes 1, in order to electrically separate the battery module 2 or the individual battery cells 3 installed within it at a relatively low voltage level of the series circuit within each of the tubular volumes 1.

In the battery module 2 depicted on the far left, an annular contact plate 7 is indicated in a purely exemplary form, via which an electrical parallel circuit of all of the strings of individual battery cells 3 can be implemented in the tubular volumes 1. If the contact plate is jettisoned in the event of excessive pressure in one or more of the tubular volumes 1, all the strings of individual battery cells 3 are electrically separated, such that the entire battery module 2 is electrically switched off.

To adapt the structure to a battery housing which is not depicted here and which surrounds the individual battery modules 2, cavities can be provided, which can for example be filled by half battery modules (not depicted) having only three of the volumes 1 and a half cooling conduit 9, or which for example, as indicated here by the space labelled 13, can have electronic components such as a battery management system or electrical components such as electrical connections for the entire battery 11.

1.-8. (canceled)

9. A battery module (2), comprising:
a plurality of individual battery cells (3) configured as round cells, wherein the plurality of individual battery cells (3) are disposed one behind the other in a plurality of strings and are electrically connected in series within a respective string;
wherein each of the plurality of strings is disposed in a closed tubular volume (1);
a device for severing electrical contact of at least one string of the plurality of strings in an event of an unpermitted increase in pressure in at least one of the plurality of individual battery cells (3) disposed within the closed tubular volume (1) of the at least one string of the plurality of strings; and
at least one electrical contact plate (5, 7) in electrical contact with at least two of the plurality of strings, wherein the at least one electrical contact plate (7) is configured as a first rupture element, and/or an actuator (15) is provided which is configured to separate the at least one electrical contact plate (7) from the at least two of the plurality of strings in an event of activation.

10. The battery module (2) according to claim 9, wherein the device has a detection apparatus (14) for at least indirectly recording the increase in pressure and at least one actuator (15) triggered thereby.

11. The battery module (2) according to claim 9, wherein the device has a second rupture element (18) and wherein the second rupture element forms the electrical contact or a conductor (20) forming the electrical contact runs over the rupture element (18).

12. The battery module (2) according to claim 9, wherein a flow conduit is disposed between the respective individual battery cells (3) of a respective string and a material (12) surrounding the tubular volume (1) and wherein the flow conduit is a spiral wrapping of the individual battery cells (3) with a flexible material (8) before introducing them into the tubular volume (1).

13. The battery module (2) according to claim 9, wherein the respective tubular volumes (1) are disposed next to a cooling medium conduit (9) and wherein a plurality of the tubular volumes (1) are grouped around a cooling medium conduit (9).

14. The battery module (2) according to claim 13, wherein the plurality of tubular volumes (1) are grouped around the cooling medium conduit (9) in a completely or partially hexagonal arrangement.

15. The battery module (2) according to claim 13, wherein the cooling medium conduit (9) is connected to at least one of the tubular volumes (1) via a pressure protection device and/or a fuse.

16. The battery module (2) according to claim 11 in combination with a housing of a battery (11), wherein the housing surrounds the battery module (2) and wherein a path for exiting gases (10) in the housing of the battery (11) is releasable via the second rupture element.
